(19) United States
(12) Patent Application Publication
(10) Pub. No.: US 2011/0170288 A1
(43) Pub. Date: Jul. 14, 2011

(54) LED RETROFIT UNIT HAVING ADJUSTABLE HEADS FOR STREET LIGHTING

(75) Inventor: Steven Kim, Riverdale, NJ (US)

(73) Assignee: LED FOLIO CORPORATION, Riverdale, NJ (US)

(21) Appl. No.: 12/685,090

(22) Filed: Jan. 11, 2010

(51) Int. Cl. F21V 1/00; F21S 4/00

(52) U.S. Cl. 362/235; 362/249.02; 362/249.03

(57) ABSTRACT

Disclosed is a light emitting diode retrofit unit including a main body housing electronics having a first end and a second end, an electrical connector at the first end of the main body and rotatably attached to the main body via a commutator, a first LED module connected at the second end of the main body via a first connector, a second LED module connected to the main body via a second connector, and a plurality of LEDs in each of the first and second LED modules.

### BACKGROUND OF THE INVENTION

1. Field Of The Invention

The embodiments of the invention relate to a light emitting diode (hereinafter, abbreviated as “LED”) lamp for street lighting, and more particularly to an LED retrofit unit having adjustable heads for street lighting having adjustable heads. Although embodiments of the invention are suitable for a wide scope of applications, they are particularly suitable for street lighting applications that could have any one of many different illumination patterns.

2. Discussion Of The Related Art

Generally, street lighting refer to lighting systems that are installed along sidewalks or roadways to provide illumination for safety and security. A typical street light includes a light source, a lighting fixture for mounting the light source thereon, a power supply unit for supplying power to the light source, a timer, and a central control unit operated to turn the light source on and off. In the past, the light source was typically either a mercury bulb, a fluorescent bulb or a sodium bulb. Such a street light is designed to illuminate the surrounding adjacent to the street lamp with a predetermined luminance. In recent years, LEDs have been considered for use as light sources of street lamps due to LEDs having low power consumption, long-lifetime and improved efficiency.

LEDs are more energy efficient than either an incandescent bulb or a fluorescent bulb. An incandescent bulb converts about 3 percent of the supplied power into light at about 14-16 lumens/watt. A compact fluorescent bulb converts about 12% of the supplied power into light at about 60-72 lumens/watt. An LED converts about 18% of the supplied power into light at about 93-95 lumens/watt. The rest of the supplied power for each of the incandescent bulb, the fluorescent bulb and the LED bulb is usually expended as heat. Although the LED expends the least amount of heat because the LED is the most efficient, heat needs to be removed from the LED via a heatsink to maintain the efficiency and life-span of the LED.

An incandescent lamp uses a filament to create light. A fluorescent bulb uses a gas excited by an electric field to create light. An LED uses one or more LEDs in which each of the LEDs uses a semiconductor chip to create light. Because the LED uses a semiconductor chip, the LED can have a much longer life-span than either an incandescent bulb or a compact fluorescent bulb. LED are thus desirable for long-term installations in public infrastructure or where bulb changes may be cumbersome, such as street lights.

Street lights are usually designed to be able to implement a variety of illumination patterns to meet the illumination requirements for a myriad of different lighting applications. For example, the illumination pattern of a street light along a single-lane country road should be long an narrow to efficiently illuminate the roadway and not the surroundings. In contrast, a street light on a multi-lane city street should be oval and wide to illuminate multiple lanes of the street as well as the sidewalks. To facilitate a designation of types of illumination patterns amongst manufacturers, the Illuminating Engineering Society (“IES”) and the American National Standards Institute (“ANSI”) have categorized illumination patterns into a number of standard types.

FIGS. 1a-1e are diagrams illustrating lateral light distribution of five different illumination patterns according to standard types I-V. As shown in FIG. 1a, a street light having a type I illumination pattern is centered in the middle of the roadway. The illumination pattern is long and narrow having a preferred lateral width of 15 degrees in the cone of maximum candlepower. Type I lamps are typically mounted at a height less equal to the width of the roadway to be illuminated.

As shown in FIG. 1b, a street lamp having a type II illumination pattern is located over the curb line on the side of the roadway. The illumination pattern is shorter and wider than a type I street lamp and has a preferred lateral width of 25 degrees in the cone of maximum candlepower. Type II lamps are typically mounted at a height less than 1.75 times the width of the roadway to be illuminated.

As shown in FIG. 1c, a street lamp having a type III illumination pattern is located over the curb line on the side of the roadway. The illumination pattern is shorter and wider than a type II street lamp and has a preferred lateral width of 40 degrees in the cone of maximum candlepower. Type III lamps are typically mounted at a height less than 2.75 times the width of the roadway to be illuminated.

As shown in FIG. 1d, a street lamp having a type IV illumination pattern is located over the curb line on the side of the roadway. The illumination pattern is shorter and wider than a type III street lamp and has a preferred lateral width of 60 degrees in the cone of maximum candlepower. Type IV lamps are typically mounted at a height less than 3.75 times the width of the roadway to be illuminated.

As shown in FIG. 1e, a street lamp having a type V illumination pattern is centered in the middle of the roadway. The illumination pattern is substantially circular providing equal illumination in all directions. Type V street lamps are typically used in intersections and medians and do not have a preferred mounting height.

The illumination patterns of the prior art street lamps are determined by the shape of the reflector in the street lamp. To change the illumination pattern of a prior art street lamp, the reflector must be changed. Many street lamps do not support interchangeable reflectors or considerable time and labor is required to do so. If the illumination requirements of a particular installation change over time, the entire street lamp lighting head would have to be changed at considerable cost. LED radiate light unidirectionally rather than omni-directionally like incandescent and fluorescent bulbs. The unidirectional lighting nature of an LED-type bulb prevents simply replacing an incandescent/fluorescent bulb with an LED-type bulb. More particularly, the built-in reflector for a incandescent/fluorescent bulb in a street lamp can not be used with an LED-type bulb to achieve the illumination pattern for which the street lamp was designed to produce.

### SUMMARY OF THE INVENTION

Accordingly, embodiments of the invention are directed to a LED retrofit unit for street lighting having adjustable heads that substantially obviates one or more of the problems due to limitations and disadvantages of the related art.

An object of embodiments of the invention is to provide a LED retrofit unit which provides multiple IES/ANSI illumination types.

Another object of embodiments of the invention is to provide a LED retrofit unit compatible with existing street lamp infrastructure.

Another object of embodiments of the invention is to provide a LED retrofit unit provides multiple IES/ANSI illumination types without the use of a reflector.

Another object of embodiments of the invention is to provide an LED retrofit unit for street lamps that is more energy efficient than existing street lamp bulbs.

Additional features and advantages of embodiments of the invention will be set forth in the description which follows, and in part will be apparent from the description, or may be learned by practice of embodiments of the invention. The objectives and other advantages of the embodiments of the invention will be realized and attained by the structure particularly pointed out in the written description and claims hereof as well as the appended drawings.

To achieve these and other advantages and in accordance with the purpose of embodiments of the invention, as embodied and broadly described, the LED retrofit unit includes a main body housing electronics having a first end and a second end, an electrical connector at the first end of the main body and rotatably attached to the main body via a commutator, a first LED module connected at the second end of the main body via a first connector, a second LED module connected to the main body via a second connector, and a plurality of LEDs in each of the first and second LED modules.

In another aspect, the LED retrofit unit includes a main body housing electronics, an electrical connector on the main body, a first LED module connected to the main body at a first connection point via a first articulating connector, a second LED module connected to the main body at a second connection point via a second articulating connector, and a plurality of LEDs in each of the first and second LED modules.

In yet another aspect, the LED retrofit unit includes a main body housing electronics and having at least first, second and third connection points on first, second and third sides of the main body, respectively, an electrical connector on a fourth side of the main body, a first LED module connected to the main body at the first connection point via a first articulating connector, a second LED module connected to the main body at the second connection point via a second articulating connector, a third LED module connected to the main body at the third connection point via a third articulating connector, and a plurality of LEDs in the first, second, and third LED modules.

It is to be understood that both the foregoing general description and the following detailed description are exemplary and explanatory and are intended to provide further explanation of embodiments of the invention as claimed.

### BRIEF DESCRIPTION OF THE DRAWINGS

The accompanying drawings, which are included to provide a further understanding of embodiments of the invention and are incorporated in and constitute a part of this specification, illustrate embodiments of the invention and together with the description serve to explain the principles of embodiments of the invention.

FIGS. 1a-1e are diagrams illustrating lateral light distribution of five different illumination patterns according to standard types I-V ;

FIG. 2 is an illustration of an LED retrofit unit according to an exemplary embodiment of the invention;

FIG. 3a is an isometric illustration of the LED retrofit unit of FIG. 2;

FIG. 3b is an isometric illustration of the LED retrofit unit of FIG. 2;

FIG. 3c is a side-view of the LED retrofit unit of FIG. 2;

FIG. 3d is a side-view of the LED retrofit unit of FIG. 2;

FIG. 4 is a block diagram of the electronics for the LED retrofit unit shown in FIG. 2;

FIG. 5 is a schematic representation of the LED retrofit unit shown in FIG. 2;

FIG. 6 is a block diagram of the driver of the LED retrofit unit bulb shown in FIG. 2;

FIG. 7 is an illustration of an LED module of the LED retrofit unit shown in FIG. 2;

FIG. 8 is an assembly drawing of the articulating connector of the LED retrofit unit shown in FIG. 2;

FIG. 9 is an illustration of an LED retrofit unit according to a second exemplary embodiment of the invention;

FIG. 10a is an isometric illustration of the LED retrofit unit of FIG. 9;

FIG. 10b is an isometric illustration of the LED retrofit unit of FIG. 9;

FIG. 10c is a side-view of the LED bulb of FIG. 9;

FIG. 10d is a side-view of the LED retrofit unit of FIG. 9;

FIG. 10e is a side-view of the LED retrofit unit of FIG. 9;

FIG. 10f is a side-view of the LED retrofit unit of FIG. 9; and

FIG. 11 is an illustration of an LED retrofit unit according to the second exemplary embodiment of the invention.

### DETAILED DESCRIPTION OF THE PREFERRED EMBODIMENTS

Reference will now be made in detail to the preferred embodiments of the invention, examples of which are illustrated in the accompanying drawings. The invention may, however, be embodied in many different forms and should not be construed as being limited to the embodiments set forth herein; rather, these embodiments are provided so that this disclosure will be thorough and complete, and will fully convey the concept of the invention to those skilled in the art. In the drawings, the thicknesses of layers and regions are exaggerated for clarity. Like reference numerals in the drawings denote like elements.

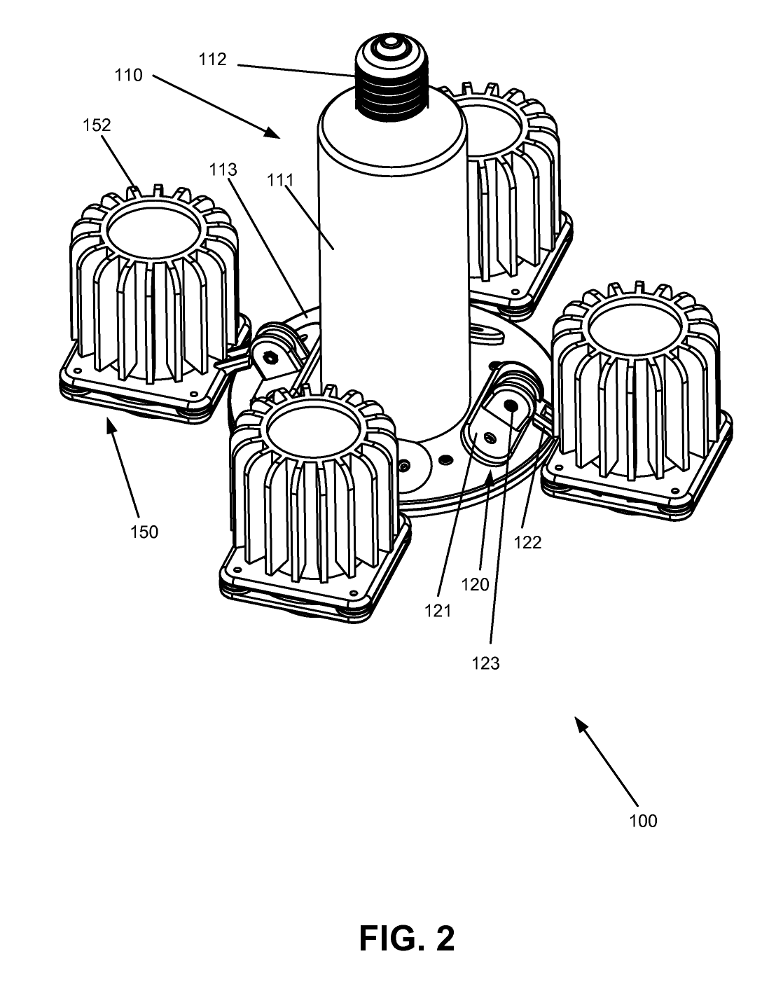

FIG. 2 is an illustration of an LED retrofit unit according to an exemplary embodiment of the invention. As shown in FIG. 2, the LED retrofit unit 100 includes a main body 110 and LED modules 150 with heatsinks 152. The LED modules 150 are connected to the main body 110 by articulating connectors 120. The main body includes a housing 111, an electrical connector 112, and a flange 113. The housing 111 contains electronics (not shown) for converting line level alternating current to pulsed direct current for use by the LED modules 150.

The electrical connector 112 can be an Edison E27 or E40 screw-in type connector. Edison E27 connectors are commonly used in household lighting applications. An Edison E40 connector is commonly used in high wattage applications, such as street lamps and stadium lights.

The articulating connector 120 includes a base 121, an arm 122, and an articulation point 123. The base 121 and the arm 122 of the articulating connector 120 are jointed at the articulation point 123 to facilitate manual manipulation of the arm 122 about the articulation point 123. The base 121 of the articulating connector 120 is mounted to the flange 113 of the main body 110 on one side and an end of the arm 122 at the articulation point 123. The other end of the arm 122 of the articulating connector 120 is connected the LED module 150. The articulating connector 120 allows the LED modules 150 can be reoriented with respect to the main body 110 within the mechanical limits of the articulation point 123.

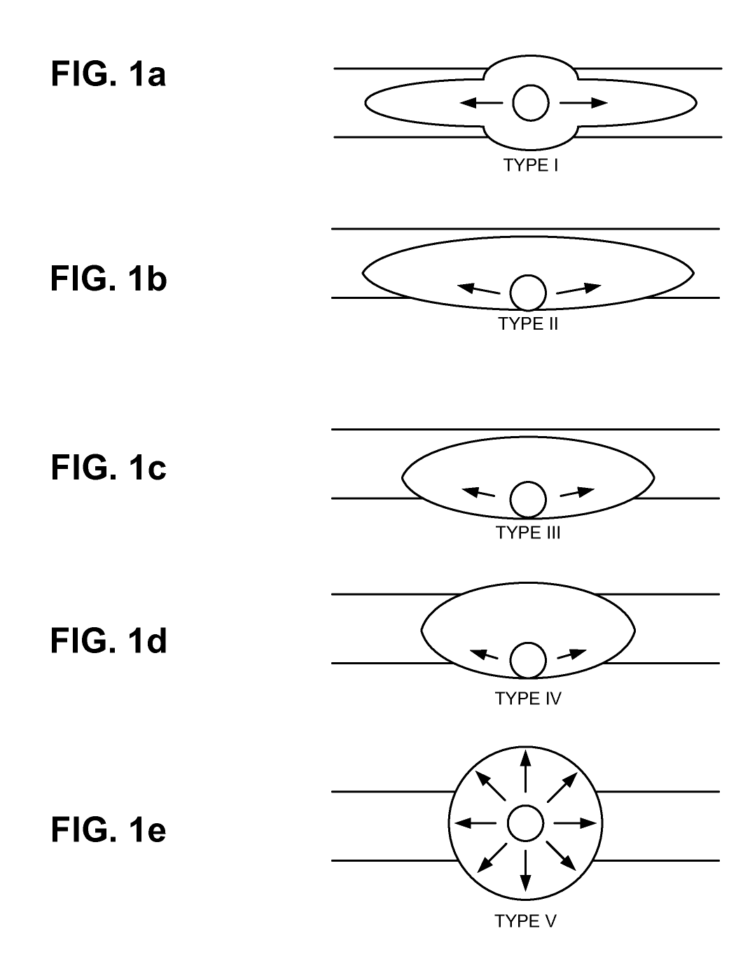

Reorientation of the LED modules can be desirable when installing the retrofit LED unit 100 into a variety of street lamps. The beam type of many existing street lamps is determined by a reflector in the housing of the lamp. Light radiated from a standard bulb is focused by the reflector into a beam type specific to the lighting application. However, in this exemplary embodiment of an LED retrofit unit, all light is radiated in substantially the same direction from an LED module 250. If the street lamp has a built-in reflector for a standard-type bulb, the reflector does not receive any light and the light emitting from the street lamp cannot be redirected by the reflector into a standard beam pattern, as illustrated in FIG. 1. Exemplary embodiments of the invention allow the LED modules 150 to be oriented via the articulating connector 120 to achieve a beam pattern like one of the standard beam patterns, such as illustrated in FIG. 1.

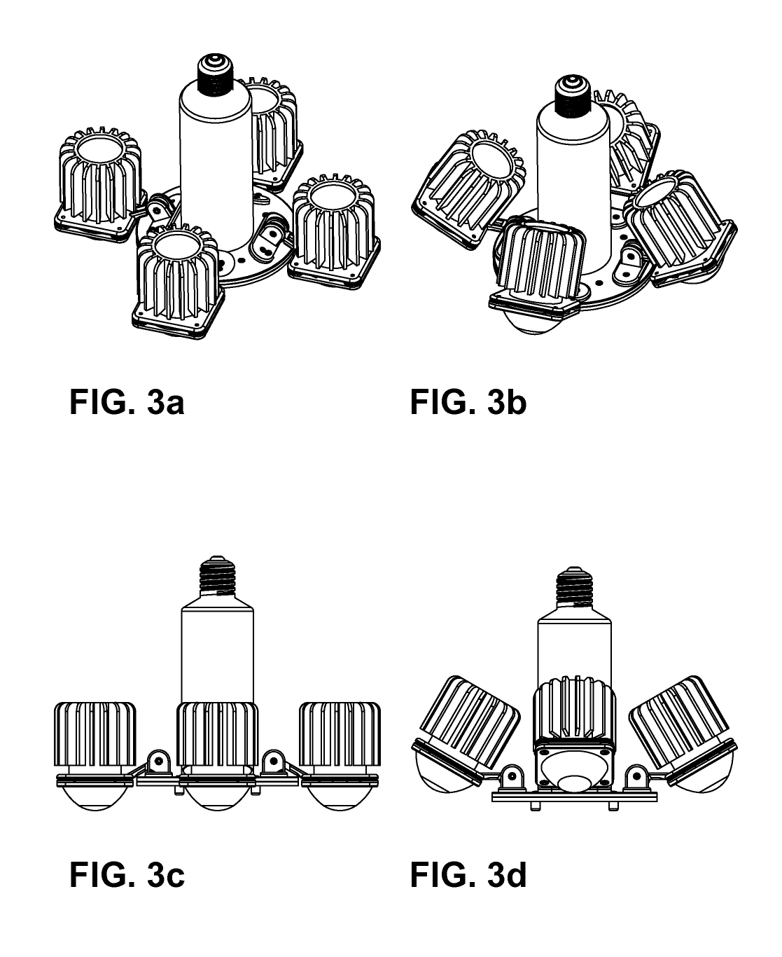

FIG. 3a is an isometric illustration of the LED retrofit unit of FIG. 2 and FIG. 3c is a side-view of the LED retrofit unit of FIG. 2. As shown in FIG. 3a and FIG. 3c, the articulating connectors 120 are configured such that the LED modules 150 are oriented at a reference angle of 0° with respect to the flange 113. Such a configuration is desirable for concentrated light radiation over a small area.

FIG. 3b is an isometric illustration of the LED retrofit unit of FIG. 2 and FIG. 3d is a side-view of the LED retrofit unit of FIG. 2. As shown in FIG. 3b and FIG. 3d, the articulating connectors 120 are configured such that the LED modules 150 are oriented at a reference angle of 30° with respect to the flange 113. Such a configuration is desirable for dispersed light radiation over a large area.

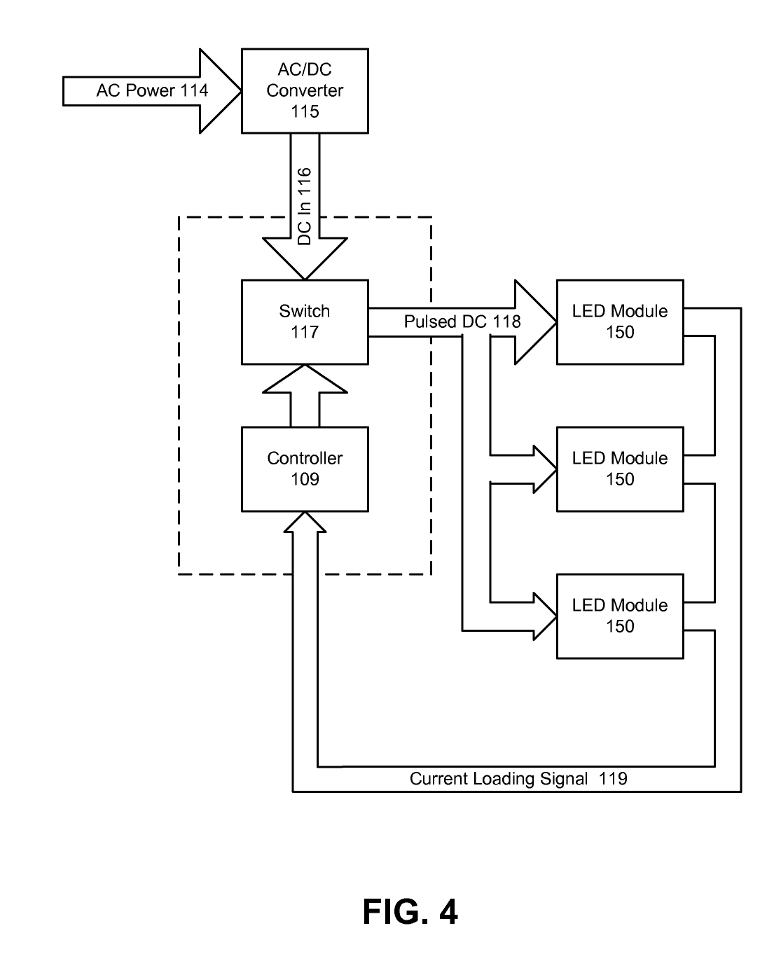

FIG. 4 is a block diagram of the electronics for the LED retrofit unit shown in FIG. 2. Referring to FIG. 2 and FIG. 4, alternating current power 114 is delivered through the electrical connector 112 and passes through an internal power converter 115 to be converted to direct current power 116. The internal power converter 115 can include a line filter, a bridge diode and other electrical components. The direct current power 116 is switched by a switch 117 to produced pulsed direct current power 118 and is then supplied to the LED modules 150. The current loading signal 119 produced by the plurality of LED modules 150 is checked by the controller 109 to vary the resonant frequency of the switch 117, so that the driving of the LED lamp can be stabilized by feedback control. Collectively, the switch 117 and the controller 109 are called a driver 107

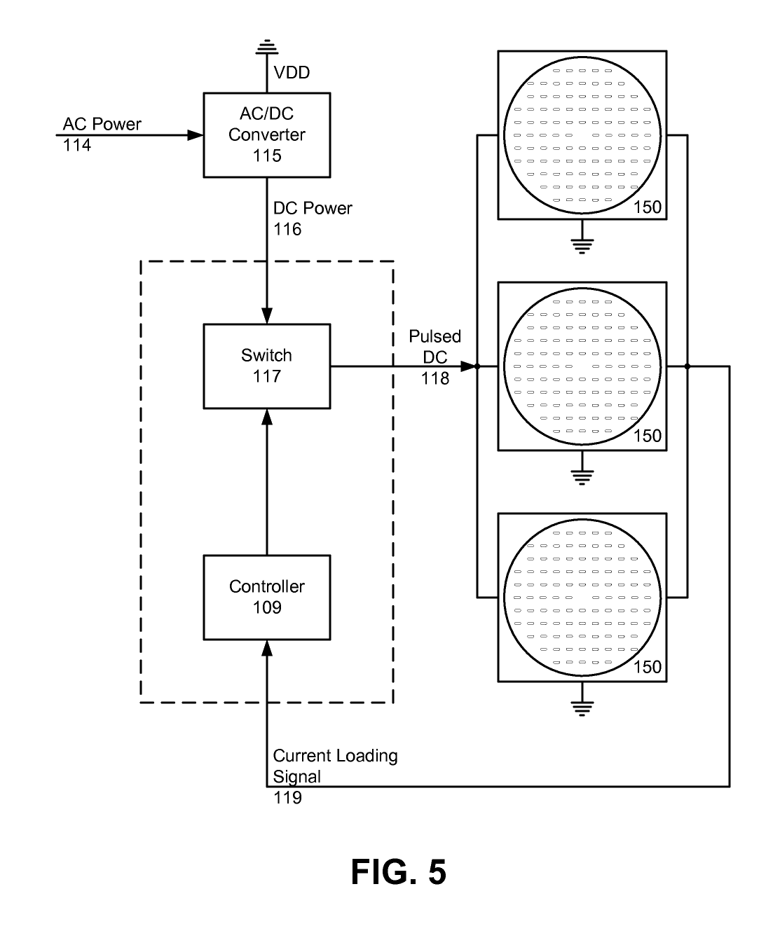

FIG. 5 is a schematic representation of the LED retrofit unit shown in FIG. 2. Referring to FIG. 5, alternating current power 114 passes through an internal power converter 115 to be converted to direct current power 116. The internal power converter 115 can include a line filter, a bridge diode and other electrical components. The direct current power 116 is switched by a switch 117 to produced pulsed direct current power 118 which is then supplied to the LED modules 150. The current loading signal 119 produced by the plurality of LED modules 150 is checked by the controller 109 to vary the resonant frequency of the switch 117, so that the driving of the LED lamp can be stabilized by feedback control. Collectively, the switch 117 and the controller 109 are called a driver 107

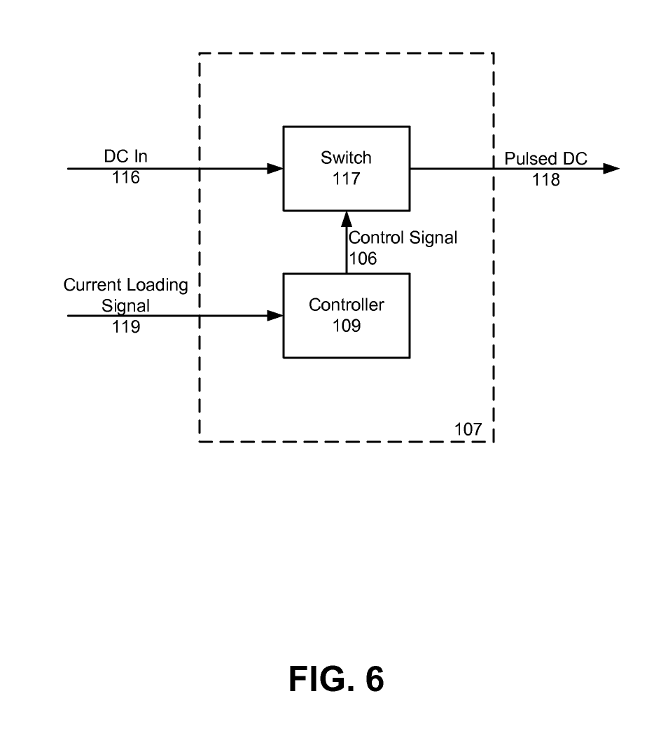

FIG. 6 is a block diagram of the driver of the LED retrofit unit shown in FIG. 2. Referring to FIG. 6, the driver module 107 accepts direct current power 116, a current loading signal 119, and in response, provides pulsed direct current power 118. The current loading signal 119 is produced by the LED modules (not shown) connected to the pulsed direct current power 118 and is a measure of the current that the LED modules are consuming. The drive module 107 checks the current loading state of the LED modules and varies the pulse width of the pulsed direct current power 118 so that the driving of the LED lamp can be stabilized by feedback control.

The drive module 107 contains a controller 109 and a switch 117. The controller 109 is coupled to receive a current loading signal 119 and in response produce a control signal 106. The current loading signal 119 is produced by the LED modules (not shown) and is a measure of the current that the LED modules are consuming. The switch 117 is coupled to receive the control signal 106 from the controller 109, direct current power 116, and in response, vary the pulse width of the pulsed direct current power 118 so that the driving of the LED lamp can be stabilized by feedback control.

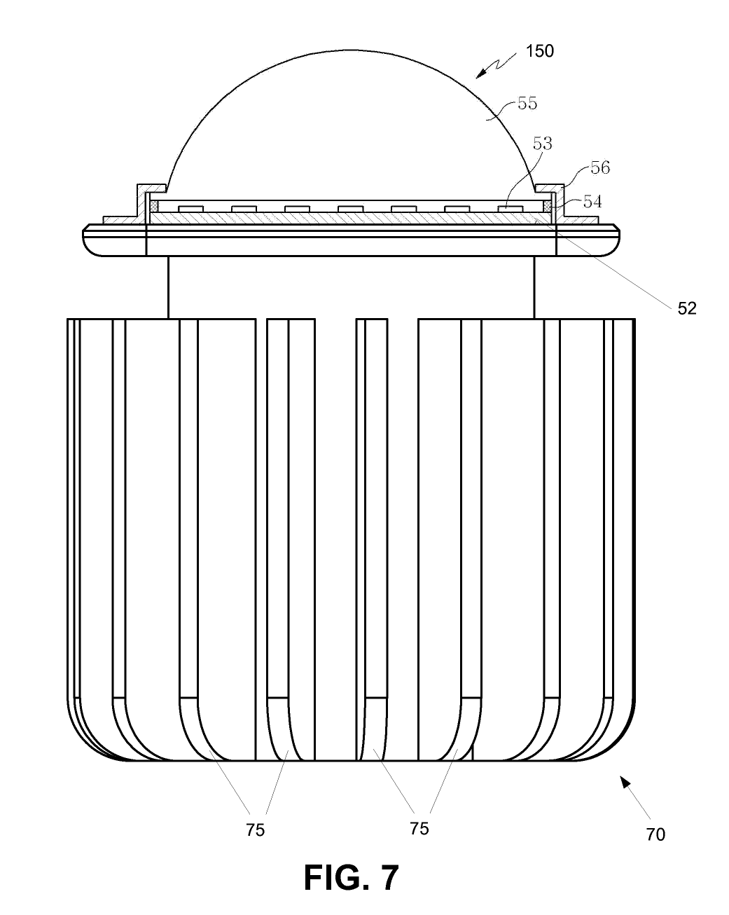

FIG. 7 is an illustration of an LED module of the LED retrofit unit shown in FIG. 2. As shown in FIG. 7, an LED module 150 includes a lens 55, LEDs 53, a circuit board 52, spacers 54, retention clips 56, and a heatsink 70.

The circuit board 52 is populated with a plurality of LEDs 53. The LEDs can be electrically connected in parallel so that the failure of a single LED 53 does not effect the operation of other LEDs 53. Alternatively, the LEDs 53 can be connected in small groups of LEDs 53 connected in series with multiple small groups of LEDs 53 being connected in parallel. This arrangement has the effect of summing the voltage required to illuminate a group of series connected LEDs 53. The summing effect is beneficial because some efficiencies are lost in the conversion of AC power to low voltage DC. While individual LEDs 53 may have an operating voltage of 1.3-1.8 volts, much technology exists in efficiently converting AC power to 12V DC. Accordingly, a series implementation can provide additional benefits over a parallel implementation. For example, eight 1.5V LEDs can be connected in series to obtain a group requiring 12V and the implementation can utilize well-known power conversion technologies to convert AC line voltage to 12V DC.

The circuit board 52 can be made from mica or other suitable substance providing rigidity, resistance to varied temperatures, low cost, and electrical non-conductivity. The circuit board can be implemented with a network of lead or tin traces to allow for the passage of electricity and electrical signals. The electrical traces can be implemented in larger proportions than electrically necessary to serve the additional purpose of heat dissipation and heat conduction.

Spacers 54 are used to separate the lens 55 from the LEDs 53. It is desirable to have some space between the lens 55 and the LEDs 53 so that the light radiating from the LEDs 53 will have some space to diffuse before contacting the lens 55. The lens 55, the circuit board 52 and the spacers 54 are held together with retention clips 54. The retention clips 54 can be attached to the heatsink 70 or, in the alternative to the circuit board 52.

The heatsink 70 is populated with a series of fins 75 to facilitate heat exchange between the heatsink 70 and the environment. The heatsink 70 can be made from a material that is not electrically conductive to prevent electrical continuity between adjacent traces of the LED module 150 through the heatsink 70. Alternatively, the heatsink 70 can be made from an electrically conductive material such as copper, aluminum, or steel that is then sheathed in a thin layer of thermally conductive but not electrically conductive material as mica or aluminum nitride. The heatsink 70 can conduct heat from the LED module 150 by direct contact with the LED module 150.

Alternatively, the heatsink 70 and LED module 150 can be joined using thermal paste to increase the thermally conductive surface area. Thermal paste can contain thermally conductive ceramic compounds such as beryllium oxide, aluminum nitride, aluminum oxide, zinc oxide, or silicon dioxide. Thermal paste can also contain thermally conductive metal or carbon compounds such as silver, aluminum, liquid gallium, diamond powder, or carbon fibers. The thermal paste can use silicone as a medium to suspend the thermally conductive materials.

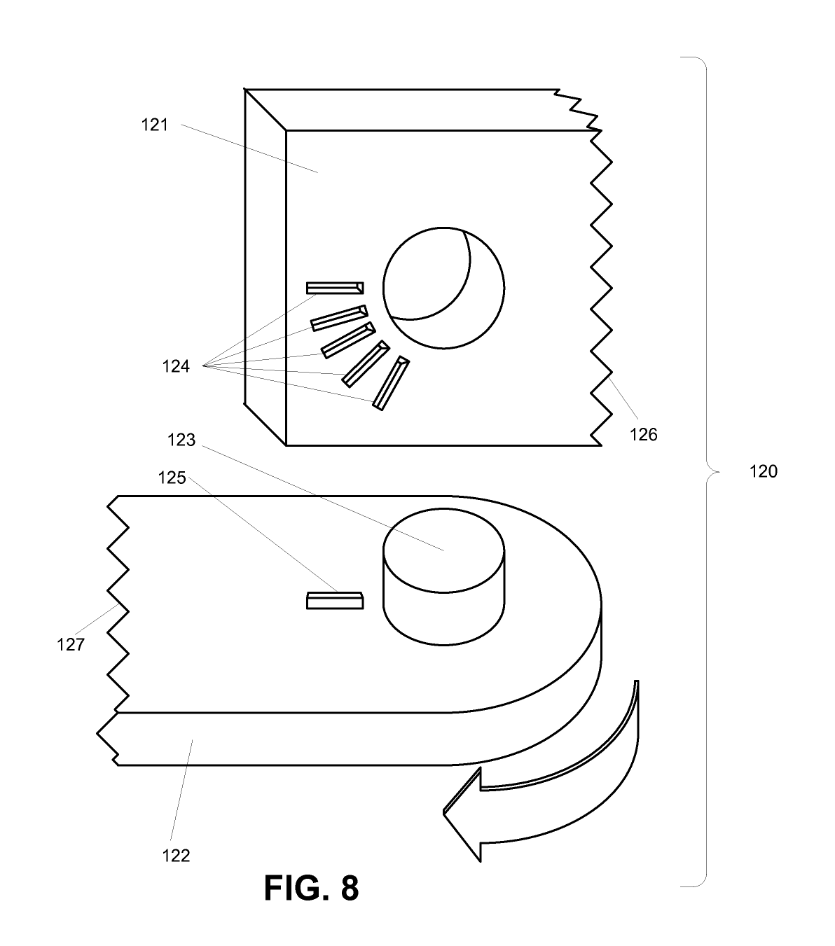

FIG. 8 is an assembly drawing of the articulating connector of the LED retrofit unit shown in FIG. 2. Referring to FIG. 8 and FIG. 2, an articulating connector 120 includes a base 121 and an arm 122. The base 121 includes multiple recessed notches 124 and a void 128. The arm 122 includes a hinge pin 129 and a raised inclusion 125. Together, the void 128 and the hinge pin 129 form the articulation point 123.

The base 121 can be connected to the flange 113 of the main body 110 at point 126. The arm can be connected to an LED module 150 at point 127. The arm 122 can be introduced into the base 121 such that the hinge pin 129 enters into the void 128 forming an articulation point 123. The raised inclusion 125 can interlock with one of the multiple recessed notches 124 to fix the arm at a predetermined angle. The notches 124 can be positioned such that the arm 122 and the attached LED module 150 will achieve an illumination type consistent with one of the IES/ANSI standard types.

While the articulating connector illustrated in FIG. 8 and herein described discloses an articulating connector achieving articulation by means of a hinge, it is to be appreciated by one having ordinary skill in the art that other methods of articulation are equally suited to achieve the objects of the invention and that the invention should thus not be limited to the disclosed embodiment. Other methods of articulation are contemplated including a ball and socket and a gooseneck.

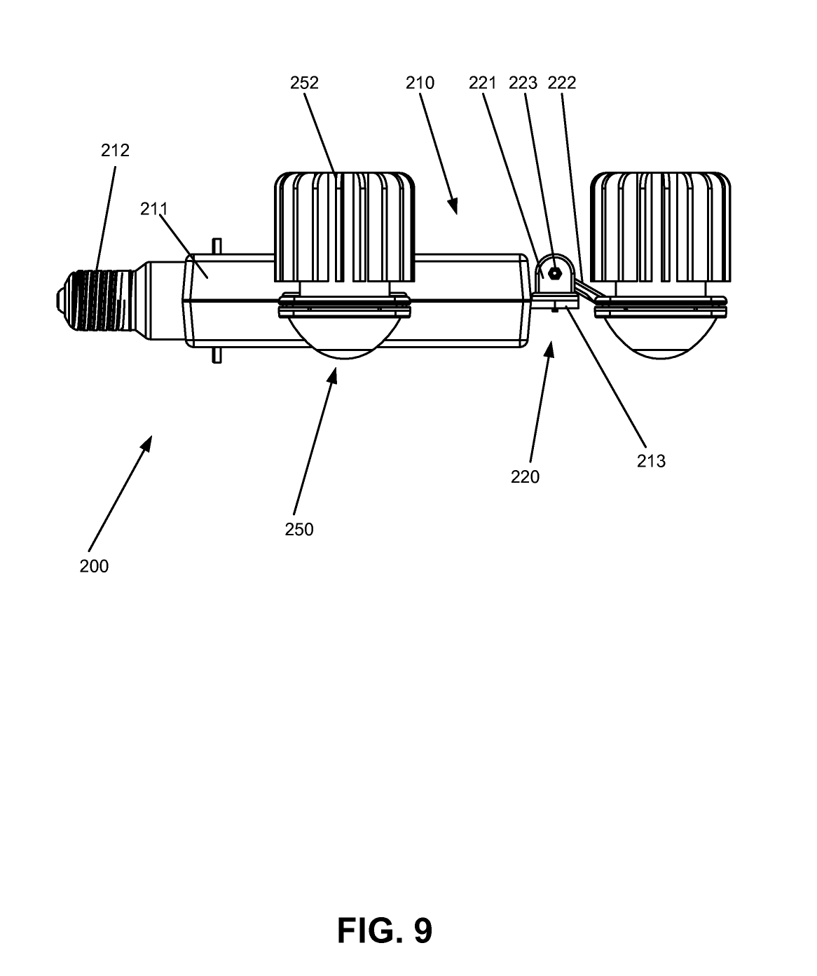

FIG. 9 is an illustration of an LED retrofit unit according to a second exemplary embodiment of the invention. As shown in FIG. 9, the LED retrofit unit 200 includes a main body 210 and LED modules 250 with heatsinks 252. The LED modules 250 are connected by articulating connectors 220 on three different sides of the main body 210. The main body includes a housing 211, an electrical connector 212 on one side of the main body 210, and a number of connection points 213 on other sides of the main body 210. The housing 211 contains electronics (not shown) for converting line level alternating current to pulsed direct current for use by the LED modules 250.

The articulating connector 220 includes a base 221, an arm 222, and an articulation point 223. The base 221 and the arm 222 of the articulating connector 220 are jointed at the articulation point 223 to facilitate manual manipulation of the arm 222 about the articulation point 223. The base 221 of the articulating connector 220 is mounted to a connection point 213 of the main body 210 on one side and an end of the arm 222 at the articulation point 223. The other end of the arm 222 of the articulating connector 220 is connected the LED module 250. The articulating connector 220 allows the LED modules 250 can be reoriented with respect to the main body 210 within the mechanical limits of the articulation point 223.

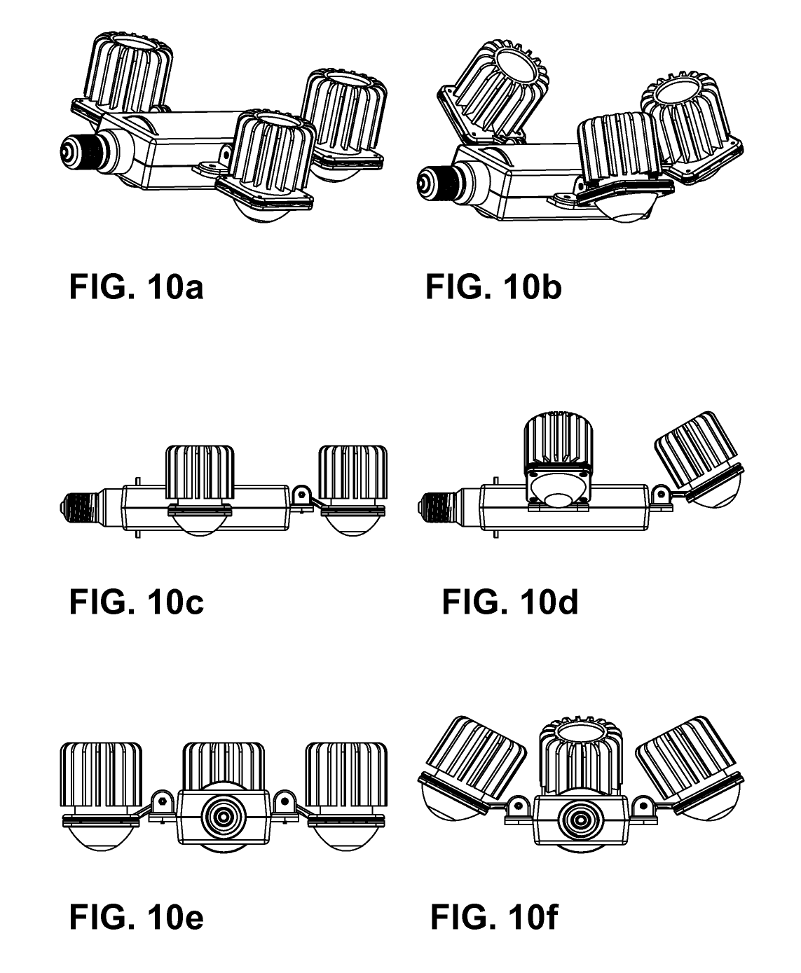

FIG. 10a is an isometric illustration of the LED retrofit unit of FIG. 9, FIG. 10c is a side-view of the LED retrofit unit of FIG. 9, and FIG. 10e is a side-view of the LED retrofit unit of FIG. 9. As shown in FIG. 10a, FIG. 10c, and FIG. 10e, the articulating connectors 220 are configured such that the LED modules 250 are oriented at a reference angle of 0° with respect to the connection point 213. Such a configuration is desirable for concentrated light radiation over a small area.

FIG. 10b is an isometric illustration of the LED retrofit unit of FIG. 9, FIG. 10d is a side-view of the LED retrofit unit of FIG. 9, and FIG. 10f is a side-view of the LED retrofit unit of FIG. 9. As shown in FIG. 10b, FIG. 5d, and FIG. 10f, the articulating connectors 220 are configured such that the LED modules 250 are oriented at a reference angle of 30° with respect to the connection point 213. Such a configuration is desirable for dispersed light radiation over a large area.

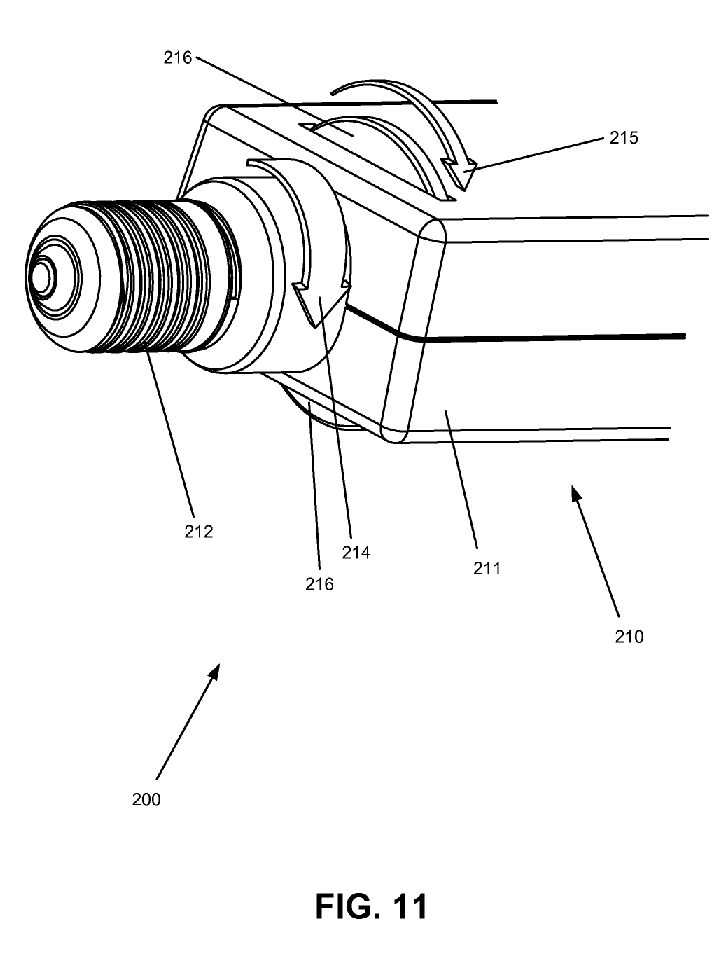

FIG. 11 is an illustration of an LED retrofit unit according to the second exemplary embodiment of the invention. As shown in FIG. 11, the LED retrofit unit 200 includes a main body 210. Other components have been omitted for clarity. The main body includes a housing 211, an electrical connector 212, and an electrical commutator 216. The housing 211 contains electronics (not shown) for converting line level alternating current to pulsed direct current for use by the LED modules (not shown).

The commutator 216 is rotatably attached to the housing 211 and the electrical connector 212 to facilitate rotation of the electrical connector 212 independent of the housing 211. Rotation can be achieved by the installer of the LED retrofit unit 200 by manually manipulating the commutator 216 in the direction of the arrow 215. Alternatively, the installer of the LED retrofit unit 200 can achieve rotation by manually manipulating the electrical connector 212 in the direction of the arrow 214. Such a design enables rapid installation of the LED 200 in small areas and ensures proper alignment of the LED retrofit unit 200. Depending on direction of the threads of the electrical connector 212, the commutator 216 and the electrical connector 212 also permit rotation in a direction opposite the arrows 214 and 215.

It will be apparent to those skilled in the art that various modifications and variations can be made in the LED retrofit unit for street lighting having adjustable heads of embodiments of the invention without departing from the spirit or scope of the invention. Thus, it is intended that embodiments of the invention cover the modifications and variations of this invention provided they come within the scope of the appended claims and their equivalents.

What is claimed is:

1. A light emitting diode retrofit unit, comprising:
a main body housing electronics having a first end and a second end;
an electrical connector at the first end of the main body and rotatably attached to the main body via a commutator;
a first LED module connected at the second end of the main body via a first connector;
a second LED module connected to the main body via a second connector; and
a plurality of LEDs in each of the first and second LED modules.

2. The light emitting diode retrofit unit according to claim 1, wherein the first connector is a hinge.

3. The light emitting diode retrofit unit according to claim 1, wherein the first connector is a ball and socket.

4. The light emitting diode retrofit unit according to claim 1, wherein the first connector has a plurality of set points which facilitate adjustment of the first LED module.

5. The light emitting diode retrofit unit according to claim 1, further comprising: a lens which covers the plurality of LEDs on the first LED module.

6. The light emitting diode retrofit unit according to claim 1, further comprising: a heatsink attached to the first LED module.

7. The light emitting diode retrofit unit according to claim 1, wherein the electrical connector is an Edison E27 screw-in type connector.

8. A light emitting diode retrofit unit, comprising:
a main body housing electronics;
an electrical connector on the main body;
a first LED module connected to the main body at a first connection point via a first articulating connector;
a second LED module connected to the main body at a second connection point via a second articulating connector; and
a plurality of LEDs in each of the first and second LED modules.

9. The light emitting diode retrofit unit according to claim 8, wherein the first articulating connector is a hinge.

10. The light emitting diode retrofit unit according to claim 8, wherein the first articulating connector is a ball and socket.

11. The light emitting diode retrofit unit according to claim 8, wherein the first articulating connector has a plurality of set points which facilitate adjustment of the first LED module.

12. The light emitting diode retrofit unit according to claim 8, further comprising: a lens which covers the plurality of LEDs on the first LED module.

13. The light emitting diode retrofit unit according to claim 8, further comprising: a heatsink connected to the first LED module.

14. The light emitting diode retrofit unit according to claim 8, wherein the electrical connector is rotatably attached to the main body via a commutator.

15. The light emitting diode retrofit unit according to claim 8, wherein the electrical connector is an Edison E27 screw-in type connector.

16. A light emitting diode retrofit unit, comprising:
a main body housing electronics and having at least first, second and third connection points on first, second and third sides of the main body, respectively;
an electrical connector on a fourth side of the main body;
a first LED module connected to the main body at the first connection point via a first articulating connector;
a second LED module connected to the main body at the second connection point via a second articulating connector;
a third LED module connected to the main body at the third connection point via a third articulating connector; and
a plurality of LEDs in the first, second, and third LED modules.

17. The light emitting diode retrofit unit according to claim 16, wherein the electrical connector is rotatably attached to the main body via a commutator.

18. The light emitting diode retrofit unit according to claim 16, wherein the electrical connector is an Edison E27 screw-in type connector.

19. The light emitting diode retrofit unit according to claim 16, wherein the first articulating connector is a hinge.

20. The light emitting diode retrofit unit according to claim 16, wherein the first articulating connector is a ball and socket.
